(19) United States
(12) Patent Application Publication
(10) Pub. No.: US 2006/0142460 A1
(43) Pub. Date: Jun. 29, 2006

(54) Fire retardant composition

(76) Inventors: Jeffrey M. Cogen, Flemington, NJ (US); Alexander B. Morgan, Midland, MI (US); Thomas S. Lin, Whippany, NJ (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/560,325

(22) PCT Filed: Jun. 10, 2004
(86) PCT No.: PCT/US04/18382

§ 371 Date: Dec. 9, 2005

Related U.S. Application Data
(60) Provisional application No. 60/477,896, filed on Jun. 12, 2003.

(51) Int. Cl. C08K 9/04; C08K 9/00

(52) U.S. Cl. 524/445; 523/200

(57) ABSTRACT

The present invention is a flame-retardant composition comprising a polyolefin polymer, a synthetic magadiite, and a flame retardant. The invention also includes a coating prepared from the flame-retardant composition as well as a wire-and-cable construction made by applying the coating over a wire or a cable. The invention also includes articles prepared from the flame-retardant composition, such as extruded sheets, thermoformed sheets, injection-molded articles, coated fabrics, roofing membranes, and wall coverings.

This invention relates to a flame-retardant composition that is useful for wire-and-cable applications. This invention also relates to wire-and-cable constructions made from the flame-retardant composition. Moreover, the flame retardant composition of this invention is generally useful for applications requiring flame retardancy such as extruded or thermoformed sheets, injection-molded articles, coated fabrics, construction (e.g., roofing membranes and wall coverings), and automotive.

### Description of the Prior Art

Generally, cables must be flame retardant for use in enclosed spaces, such as automobiles, ships, buildings, and industrial plants. Flame-retardant performance of the cable is often achieved by making the cable insulation or outer jacket from a blend of flame-retardant additives and polymeric materials.

Examples of flame-retardant additives and mechanisms for their use with polymers are described in Menachem Lewis & Edward D. Weil, Mechanisms and Modes of Action in Flame Retardancy of Polymers, in FIRE RETARDANT MATERIALS 31-68 (A. R. Horrocks & D. Price eds., 2001) and Edward D. Weil, Synergists, Adjuvants, and Antagonists in Flame-Retardant Systems, in FIRE RETARDANCY OF POLYMERIC MATERIALS 115-145 (A. Grand and C. Wilke eds., 2000).

Flame-retardant additives for use in polyolefin-based compositions include metal hydroxides and halogenated compounds. Useful metal hydroxides include magnesium hydroxide and aluminum trihydroxide, and useful halogenated compounds include ethylene bis(tetrabromophthalimide) and decabromodiphenyloxide.

While flame-retardant additives may operate by one or more mechanisms to inhibit the burning of the polymeric composition made from or containing the additives, metal hydroxides endothermically liberate water upon heating during combustion. When used in polyolefin-based compositions, metal hydroxides can unfortunately liberate water at elevated processing temperatures and thereby adversely affect fabrication and extrusion of insulating or jacketing layers. Significantly, such release of water can also cause the composition to foam and thereby result in rough surfaces or voids in the insulation or jacket layer.

Because the quantity of a flame-retardant additive in a polyolefin-based composition can directly affect the composition's flame-retardant performance, it is often necessary to use high levels of flame retardant additives in the composition. For example, a wire-and-cable composition may contain as much as 70 percent by weight of inorganic fillers or 25 percent by weight of halogenated additives. Unfortunately, the use of high levels of flame-retardant additives can be expensive and degrade processing of the composition as well as degrade the insulating or jacketing layer's electrical, physical, and mechanical properties. Accordingly, it may be necessary to balance flame retardant performance against cost, processing characteristics, and other properties.

EP 0 370 517 B1, EP 1 052 534 A1, WO 00/52712, WO 00/66657, WO 00/68312, and WO 01/05880 describe the use of various clay and other layered silicates to improve the burning characteristics of various polymers. None of these references teaches the use of synthetic magadiite. Notably, WO 01/05880 prefers montmorillonite when compared to naturally-occurring magadiite and other smectic clay minerals.

With regard to naturally-occurring clays, silicates, and other inorganic materials, the purity, appearance, and physical properties are highly variable. All of these properties depend on the geographical source and method of processing. In fact, variability in properties may exist between materials harvested from different locations in the same mine. With regard to appearance, naturally-occurring clays and layered silicates usually possess undesirable color. Coupled with the variability in. properties is the high cost of producing suitable grades of the naturally-occurring clays and layered silicates. Those costs are directly attributable to the mining, purifying and shipping the materials.

As a naturally-occurring layered silicate, magadiite is found in some lake bed deposits. It was originally found in Magadi, Kenya. A representative structure of magadiite has a unit cell formula of M₂Si₁₄O₂₉, wherein M is an exchangeable cation. Naturally-occurring magadiite contains various impurities, which are not captured by its cell formula.

A polyolefin-based, flame-retardant composition, having desirable processing characteristics and cost advantages over conventional compositions while retaining desirable flame retardant performance, is needed. More specifically, a polyolefin-based, flame-retardant-cable composition, utilizing additives with consistent properties, is needed.

### SUMMARY OF THE INVENTION

The present invention is a flame-retardant composition comprising a polyolefin polymer, a synthetic magadiite, and a flame retardant. The invention also includes a coating prepared from the flame-retardant composition as well as a wire-and-cable construction made by applying the coating over a wire or a cable. The invention also includes articles prepared from the flame-retardant composition, such as extruded sheets, thermoformed sheets, injection-molded articles, coated fabrics, roofing membranes, and wall coverings.

Suitable wire-and-cable constructions, which may be made by applying the coating over a wire or a cable, include: (a) insulation and jacketing for copper telephone cable, coaxial cable, and medium and low voltage power cable and (b) fiber optic buffer and core tubes. Other examples of suitable wire-and-cable constructions are described in ELECTRIC WIRE HANDBOOK (J. Gillett & M. Suba, eds., 1983) and POWER AND COMMUNICATION CABLES THEORY AND APPLICATIONS (R. Bartnikas & K. Srivastava eds., 2000). Moreover, additional examples of suitable wire-and-cable constructions would be readily apparent to persons of ordinary skill in the art. Any of these constructions can be advantageously coated with a composition of the present invention.

### DESCRIPTION OF THE INVENTION

The invented flame-retardant composition comprises a polyolefin polymer, a synthetic magadiite, and a flame retardant. Suitable polyolefin polymers include polyethylene polymers, polypropylene polymers, and blends thereof.

Polyethylene polymer, as that term is used herein, is a homopolymer of ethylene or a copolymer of ethylene and a minor proportion of one or more alpha-olefins having 3 to 12 carbon atoms, and preferably 4 to 8 carbon atoms, and, optionally, a diene, or a mixture or blend of such homopolymers and copolymers. The mixture can be a mechanical blend or an in situ blend. Examples of the alpha-olefins are propylene, 1-butene, 1-hexene, 4-methyl-1-pentene, and 1-octene. The polyethylene can also be a copolymer of ethylene and an unsaturated ester such as a vinyl ester (e.g., vinyl acetate or an acrylic or methacrylic acid ester) or a copolymer of ethylene and a vinyl silane (e.g., vinyltrimethoxysilane and vinyltriethoxysilane).

The polyethylene can be homogeneous or heterogeneous. The homogeneous polyethylenes usually have a polydispersity (Mw/Mn) in the range of 1.5 to 3.5 and an essentially uniform comonomer distribution, and are characterized by a single and relatively low melting point as measured by a differential scanning calorimeter. The heterogeneous polyethylenes usually have a polydispersity (Mw/Mn) greater than 3.5 and lack a uniform comonomer distribution. Mw is defined as weight average molecular weight, and Mn is defined as number average molecular weight.

The polyethylenes can have a density in the range of 0.860 to 0.970 gram per cubic centimeter, and preferably have a density in the range of 0.870 to 0.930 gram per cubic centimeter. They also can have a melt index in the range of 0.1 to 50 grams per 10 minutes. If the polyethylene is a homopolymer, its melt index is preferably in the range of 0.75 to 3 grams per 10 minutes. Melt index is determined under ASTM D-1238, Condition E and measured at 190 degrees Celsius and 2160 grams.

Low- or high-pressure processes can produce the polyethylenes. They can be produced in gas phase processes or in liquid phase processes (i.e., solution or slurry processes) by conventional techniques. Low-pressure processes are typically run at pressures below 1000 pounds per square inch (“psi”) whereas high-pressure processes are typically run at pressures above 15,000 psi.

Typical catalyst systems for preparing these polyethylenes include magnesium/titanium-based catalyst systems, vanadium-based catalyst systems, chromium-based catalyst systems, metallocene catalyst systems, and other transition metal catalyst systems. Many of these catalyst systems are often referred to as Ziegler-Natta catalyst systems or Phillips catalyst systems. Useful catalyst systems include catalysts using chromium or molybdenum oxides on silica-alumina supports.

Useful polyethylenes include low density homopolymers of ethylene made by high pressure processes (HP-LDPEs), linear low density polyethylenes (LLDPEs), very low density polyethylenes (VLDPEs), ultra low density polyethylenes (ULDPEs), medium density polyethylenes (MDPEs), high density polyethylene (HDPE), and metallocene copolymers.

High-pressure processes are typically free radical initiated polymerizations and conducted in a tubular reactor or a stirred autoclave. In the tubular reactor, the pressure is within the range of 25,000 to 45,000 psi and the temperature is in the range of 200 to 350 degrees Celsius. In the stirred autoclave, the pressure is in the range of 10,000 to 30,000 psi and the temperature is in the range of 175 to 250 degrees Celsius.

Copolymers comprised of ethylene and unsaturated esters are well known and can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of 5 to 50 percent by weight based on the weight of the copolymer, and is preferably in the range of 15 to 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of 0.5 to 50 grams per 10 minutes, and is preferably in the range of 2 to 25 grams per 10 minutes.

Copolymers of ethylene and vinyl silanes may also be used. Examples of suitable silanes are vinyltrimethoxysilane and vinyltriethoxysilane. Such polymers are typically made using a high-pressure process. Use of such ethylene vinylsilane copolymers is desirable when a moisture crosslinkable composition is desired. Optionally, a moisture crosslinkable composition can be obtained by using a polyethylene grafted with a vinylsilane in the presence of a free radical initiator. When a silane-containing polyethylene is used, it may also be desirable to include a crosslinking catalyst in the formulation (such as dibutyltindilaurate or dodecylbenzenesulfonic acid) or another Lewis or Bronsted acid or base catalyst.

The VLDPE or ULDPE can be a copolymer of ethylene and one or more alpha-olefins having 3 to 12 carbon atoms and preferably 3 to 8 carbon atoms. The density of the VLDPE or ULDPE can be in the range of 0.870 to 0.915 gram per cubic centimeter. The melt index of the VLDPE or ULDPE can be in the range of 0.1 to 20 grams per 10 minutes and is preferably in the range of 0.3 to 5 grams per 10 minutes. The portion of the VLDPE or ULDPE attributed to the comonomer(s), other than ethylene, can be in the range of 1 to 49 percent by weight based on the weight of the copolymer and is preferably in the range of 15 to 40 percent by weight.

A third comonomer can be included, e.g., another alpha-olefin or a diene such as ethylidene norbornene, butadiene, 1,4-hexadiene, or a dicyclopentadiene. Ethylene/propylene copolymers are generally referred to as EPRs and ethylene/propylene/diene terpolymers are generally referred to as an EPDM. The third comonomer can be present in an amount of 1 to 15 percent by weight based on the weight of the copolymer and is preferably present in an amount of 1 to 10 percent by weight. It is preferred that the copolymer contains two or three comonomers inclusive of ethylene.

The LLDPE can include VLDPE, ULDPE, and MDPE, which are also linear, but, generally, has a density in the range of 0.916 to 0.925 gram per cubic centimeter. It can be a copolymer of ethylene and one or more alpha-olefins having 3 to 12 carbon atoms, and preferably 3 to 8 carbon atoms. The melt index can be in the range of 1 to 20 grams per 10 minutes, and is preferably in the range of 3 to 8 grams per 10 minutes.

Any polypropylene may be used in these compositions. Examples include homopolymers of propylene, copolymers of propylene and other olefins, and terpolymers of propylene, ethylene, and dienes (e.g. norbornadiene and decadiene). Additionally, the polypropylenes may be dispersed or blended with other polymers such as EPR or EPDM. Suitable polypropylenes include TPEs, TPOs and TPVs. Examples of polypropylenes are described in POLYPROPYLENE HANDBOOK: POLYMERIZATION, CHARACTERIZATION, PROPERTIES, PROCESSING, APPLICATIONS 3-14, 113-176 (E. Moore, Jr. ed., 1996).

The synthetic magadiite may be prepared by the method disclosed in WO 01/83370 or any other suitable method. The synthetic magadiite plates should have a thickness of 0.9 nanometers and a diameter in the 200 to 1000 nanometer-size range. The synthetic magadiite stacks should preferably have a thickness between 0.9 to 200 nanometers, more preferably 0.9 to 150 nanometers, even more preferably 0.9 to 100 nanometers, and most preferably 0.9 to 30 nanometers.

Preferably, the synthetic magadiite contains synthetic platy magadiite. More preferably, the synthetic magadiite contains more than 50 percent by weight of synthetic platy magadiite. Even more preferably, the synthetic magadiite contains more than 80 percent by weight of synthetic platy magadiite. Most preferably, the synthetic magadiite contains more than 90 percent by weight of synthetic platy magadiite.

The synthetic magadiite is effective in the composition at a concentration of 0.1 percent to 15 percent by weight, based on the total formulation. Preferably, the synthetic magadiite is present in amount between 0.5 percent and 10 percent by weight.

Some of the cations (for example, sodium ions) of the magadiite can be exchanged with an organic cation, by treating the magadiite with an organic cation-containing compound. For wire and cable compositions, preferred exchange cations are imidazolium, phosphonium, ammonium, alkyl ammonium, dialkylammonium, trialkylammonium, and tetralkylammonium. An example of a suitable ammonium compound is di(hydrogenated tallowalkyl) dimethyl ammonium. Preferably, the cationic coating will be present in 15 to 50 percent by weight, based on the total weight of magadiite plus cationic coating. In the most preferred embodiment, the cationic coating will be present at greater than 30 percent by weight, based on the total weight of magadiite plus cationic coating. Another preferred ammonium coating is octadecyl ammonium.

The composition may contain a coupling agent to improve the compatibility between the polyolefin polymer and the magadiite. Examples of coupling agents include silanes, titanates, zirconates, and various polymers grafted with maleic anhydride. Other coupling technology would be readily apparent to persons of ordinary skill in the art and is considered within the scope of this invention.

Suitable flame retardants are metal hydroxides, halogenated flame retardants, and other known flame retardants. The preferred metal hydroxide compounds are aluminum trihydroxide (also known as ATH or aluminum trihydrate) and magnesium dihydroxide (also known as magnesium hydroxide). The preferred halogenated flame retardants are brominated flame retardants and chlorinated flame retardants.

When the flame retardant is a metal hydroxide, its surface may be coated with one or more materials, including silanes, titanates, zirconates, carboxylic acids, and maleic anhydride-grafted polymers. The average particle size may range from less than 0.1 micrometers to 50 micrometers. In some cases, it may be desirable to use a metal hydroxide having a nano-scale particle size. The metal hydroxide may be naturally occurring or synthetic.

The flame-retardant composition may contain other flame-retardant additives. Other suitable non-halogenated flame retardant additives include red phosphorus, silica, calcium carbonate, alumina, titanium oxides, talc, clay, organo-modified clay, zinc borate, antimony trioxide, wollastonite, mica, silicone polymers, phosphate esters, hindered amine stabilizers, ammonium octamolybdate, intumescent compounds or blends, and expandable graphite. Suitable halogenated flame retardant additives include decabromodiphenyl oxide, decabromodiphenyl ethane, ethylene-bis (tetrabromophthalimide), and dechlorane plus.

In addition, the composition may contain other additives such as antioxidants, stabilizers, blowing agents, carbon black, pigments, processing aids, peroxides, cure boosters, clays, other layered silicates, and surface active agents to treat fillers may be present. Furthermore, the composition may be thermoplastic or crosslinked.

In a preferred embodiment, the flame-retardant composition comprises (a) a polyolefin polymer selected from the group consisting of polyethylene polymers and polypropylene polymers, (b) a synthetic magadiite containing more than 50 percent by weight of synthetic platy magadiite, and (c) a metal hydroxide selected from the group consisting of aluminum trihydroxide and magnesium dihydroxide

In another embodiment of the present invention, the invention is a coating prepared from the flame-retardant composition.

In yet another embodiment of the present invention, a variety of methods for preparing suitable wire-and-cable constructions are contemplated and would be readily apparent to persons of ordinary skill in the art. For example, conventional extrusion processes may be used to prepare a flame-retardant wire or cable construction by applying the flame-retardant composition as a coating over a wire or a cable.

In another embodiment of the present invention, the invention is an article prepared from the flame-retardant composition, where the article is selected from the group consisting of extruded sheets, thermoformed sheets, injection-molded articles, coated fabrics, roofing membranes, and wall coverings. For these applications, it is contemplated that the flame-retardant composition may be used to prepare articles in a variety of processes including extrusion, thermoforming, injection molded, calendering, and blow molding as well as other processes readily apparent to persons of ordinary skill in the art.

### EXAMPLES

The following non-limiting examples illustrate the invention.

Comparative Examples 1-3 and Example 4

The exemplified compositions were prepared using a Brabender™ mixer equipped with a 250-ml mixing bowl. The mixer was set to a mixing temperature of 120 degrees C and mixing rate of 100 RPM. The mixer was initially charged with duPont Elvax 265™ ethylene vinylacetate copolymer (“EVA”). The ethylene vinylacetate copolymer contained 28 percent vinyl acetate by weight and had a melt index of 3 grams/10 min.

After the EVA was fully melted, the mixer was then charged with (a) the selected montmorillonite clay or synthetic magadiite and (b) magnesium hydroxide. The EVA, the clay, and the magnesium hydroxide were added at the weight ratios of 38.20:5.00:50.00 respectively.

For Comparative Example 1, the selected montmorillonite was Cloisite 20A™ montmorillonite clay, having been treated with 38 percent by weight di(hydrogenated tallowalkyl)dimethyl ammonium and available from Southern Clay Products. For Comparative Example 2, the selected montmorillonite was Nanomer I.30P™ montmorillonite clay, having been treated with 30 percent by weight of octadecylammonium and available from Nanocor, Inc. For Comparative Example 3, the selected montmorillonite was Nanomer I.44PA™ montmorillonite clay, having been treated with 40 percent by weight of dimethyldialkylammonium and available from Nanocor, Inc.

The synthetic magadiite for Example 4 was prepared according to the method disclosed in WO 01/83370 A2 and treated with 40 percent by weight di(hydrogenated tallowalkyl)dimethyl ammonium. For all examples, the magnesium hydroxide had a surface area of 6.1 m²/g, as determined by the BET method, and an average particle size of 0.8 microns (800 nanometers) and contained a fatty-acid surface treatment.

The remaining components were added sequentially. The remaining components included (i) 0.40 percent by weight of Chimassorb 119FL™N,N′″-[1,2-ethanediylbis[((4,6-bis[butyl-(1,2,2,6,6-pentamethyl-4-piperidinyl) amino]-1,3,5-triazin-2-yl]imino]-3,1-propanediyl]] bis[N′,N″- dibutyl-N′,N″- bis (1,2,2,6,6-pentamethyl-4-piperidinyl) -1,3,5-triazine-2,4,6-triamine], (ii) 0.10 percent by weight of distearyl thio dipropionate, (iii) 6.00 percent by weight of a maleic anhydride grafted polyethylene coupling agent, (iv) 0.20 percent by weight of Irganox 1010FF™ tetrakis [methylene (3,5-di-tert-butyl-4-hydroxyhydro-cinnamate)] methane, and (v) 0.10 percent by weight of Irganox MD 1024™ 1,2-bis(3,5-di-tert-butyl-4-hydroxyhydrocinnamoyl)-hydrazine. Each of the Chimassorb and Irganox materials was obtained from Ciba Specialty Chemicals Inc. After all of the components were added, the mixing time was continued for 15 minutes.

The compositions were then removed from the mixer and prepared in to test specimens suitable for testing in the UL-94 Vertical Flame Test and for measuring tensile properties according to ASTM D683. The flame test specimens were 0.125 inch thick plaques while the tensile test specimens were 0.020 inch tapes extruded at 200 degrees Celsius. The tensile test was conducted at a rate of 20 inches per minute using an Instron Tensile Tester. The selected clay or synthetic magadiite was also evaluated for their color. The test results are provided in Table I.

In the UL-94 test, a flame is applied to a test specimen and the duration of burning after the flame application is noted. A shorter time represents better performance. An UL-94 rating of V0 is the best rating possible and indicates that a material self extinguishes quickly without releasing flaming drops while burning.

TABLE I

| | | | |
|---|---|---|---|
| Comp. 1 | Comp. 2 | Comp. 3 | Ex. 4 |

UL-94 Vertical Burn

| Rating | V0 | V0 | V0 | V0 |
|---|---|---|---|---|
| Total burn time (seconds) | 8 | 0 | 0 | 0 |

Tensile Properties

| | | | | |
|---|---|---|---|---|
| Stress @ Max Load (psi) | 1881 | 1918 | 1760 | 1862 |
| percent Strain @ Break | 213 | 198 | 229 | 176 |
| 1 percent Secant Modulus | 40,233 | 30,986 | 26,907 | 20,550 |
| (psi) | | | | |
| 2 percent Secant Modulus | 31,864 | 29,325 | 23,191 | 19,905 |
| (psi) | | | | |
| 5 percent Secant Modulus | 19,996 | 20,498 | 16,344 | 15,869 |
| (psi) | | | | |

Color of Clay/Magadiite

| | | | |
|---|---|---|---|
| Tan | Tan | Tan | White |

1. A flame retardant composition comprising:
a. a polyolefin polymer;
b. a synthetic magadiite; and
c. a flame retardant.

2. The flame retardant composition of claim 1 wherein the polyolefin polymer is selected from the group consisting of polyethylene polymers and polypropylene polymers.

3. The flame retardant composition of claim 1 wherein the synthetic magadiite is platy.

4. (canceled)

5. (canceled)

6. The flame retardant composition of claim 3 wherein the synthetic magadiite is treated with an organic cation.

7. (canceled)

8. The flame retardant composition of claim 1 wherein the flame retardant is selected from the group consisting of halogenated flame retardants and metal hydroxides.

9. (canceled)

10. The flame retardant composition of claim 8 wherein the flame retardant is a metal hydroxide selected from the group consisting of aluminum trihydroxide and magnesium dihydroxide.

11. The flame retardant composition of claim 10 wherein the surface of the metal hydroxide is coated with a material selected from the group consisting of silanes, titanates, zirconates, carboxylic acids, and maleic anhydride-grafted polymers.

12. (canceled)

13. (canceled)

14. A flame retardant composition comprising:
a. a polyolefin polymer selected from the group consisting of polyethylene polymers and polypropylene polymers;
b. a synthetic magadiite containing more than 50 percent by weight of synthetic platy magadiite; and
c. a metal hydroxide selected from the group consisting of aluminum trihydroxide and magnesium dihydroxide.

15. A coating prepared from the flame retardant composition of claim 1 or claim 14.

16. A flame-retardant wire or cable construction prepared by applying the coating of claim 15 over a wire or cable.
